(19) United States
(12) Patent Application Publication
(10) Pub. No.: US 2008/0050173 A1
(43) Pub. Date: Feb. 28, 2008

(54) Connecting element

(75) Inventors: Wolfgang Bruder, Simmersfeld (DE); Horst Schober, Neuweiler (DE)

Correspondence Address: KOHLER SCHMID MOEBUS, RUPPMANNSTRASSE 27, D-70565 STUTTGART, omitted

(73) Assignee: Veyl GmbH, Neuweiler (DE)

(21) Appl. No.: 11/892,180

(22) Filed: Aug. 20, 2007

(30) Foreign Application Priority Data
Aug. 23, 2006 (DE) 10 2006 039 569.7

(51) Int. Cl. A47B 13/02; F16B 12/48

(52) U.S. Cl. 403/83; 108/151

(57) ABSTRACT

A connection element 2, 3 for attaching a horizontal element 7, 8 to a vertical element is proposed. In this arrangement, a free end of the horizontal element 7, 8 comprises at least one top projection 18 and at least one bottom projection 17; and on the vertical element 56 at least one hooking-in aperture 20 for accommodating the top projection 18 of the horizontal element 7, 8 and at least one horizontal projection 25 for the vertical support of the bottom projection 17 of the horizontal element 7, 8 are provided, wherein a clamping element 30 with locking means 32 is provided for horizontal securing of the bottom projection 17 of the horizontal element 7, 8.

This application claims Paris Convention priority of DE 10 2006 039 569.7 filed Aug. 23, 2006 the complete disclosure of which is hereby incorporated by reference.

### BACKGROUND OF THE INVENTION

The invention relates to a connection element, preferably in modular furniture elements, for attaching a horizontal element to a vertical element. Such connection elements are, for example, provided on modular furniture desks or tables, e.g. office desks, wherein the vertical element is formed by a desk leg while the horizontal element is formed by a longitudinal support that stabilises the modular furniture desk. Such connection elements are, for example, known from the printed publications EP 0 594 939 B1, EP 0 087 498 B1, EP 0 065 036 B1 and EP 0 164 041 B1.

In known connection elements, the elements to be arranged horizontally (horizontal elements) are usually screwed to or hooked to the elements to be arranged vertically (vertical elements). When the elements are screwed together, a rigid connection free of any play is ensured. Assembling modular furniture that comprises such screw connections is, however, time consuming and complicated because the screws to be used can only be screwed in after precise positioning of the elements relative to each other. If the elements are hooked into each other this allows quick assembly of the modular furniture, however, there often remains some play between the elements that have been hooked into each other, so that modular furniture joined in this manner is often insufficiently rigid for use in offices or at exhibitions.

It is the object of the invention to provide a connection element, preferably in modular furniture elements, for attaching a horizontal element to a vertical element, the connection element avoiding the disadvantages of the state of the art, wherein, in particular, very quick and rigid assembly and disassembly of modular furniture is to be facilitated.

### SUMMARY OF THE INVENTION

The above object is met by the subjects of the patent claims. The dependent claims represent preferred embodiments of the invention.

A connection element according to the invention is suitable for attaching a horizontal element to a vertical element, in particular for modular furniture, whose elements are mostly made from metal. According to the invention, a free end of the horizontal element comprises at least one top projection and at least one bottom projection. The term “horizontal element” means that at least the free end of the element on which the top and bottom projections are provided are to be arranged horizontally. This can for example be a longitudinal support of a desk substructure (cross brace) or a desk leg with a laterally protruding free end. At least one hooking-in aperture for accommodating the top projection of the horizontal element and at least one horizontal projection for the vertical support of the bottom projection of the horizontal element are provided on the vertical element. In this arrangement, the term “vertical element” means that at least the region of the element on which the hooking-in aperture and the horizontal projection are provided is to be arranged vertically during assembly of e.g. modular furniture. The vertical element can e.g. be a desk leg or a desktop support. Furthermore, a clamping element with locking means is provided for horizontal securing of the bottom projection of the horizontal element.

By means of the connection element according to the invention, the horizontal element can be positioned on the vertical element simply and quickly. In this arrangement, the horizontal element is already assembled in a stable manner after hooking the top projection into the hooking-in aperture of the vertical element and after supporting the bottom projection on the horizontal projection, wherein precise positioning of the elements in relation to each other is ensured. Securing of this assembly is achieved by the locking means, wherein any play that may be present between the projections and the hooking-in aperture is also eliminated. In this way, quick and stable assembly of modular furniture elements is possible.

The projections of the horizontal element are preferably formed by a plate (adapter plate) that is attached to the free end of the horizontal element, the plate preferably being symmetrical relative to a horizontal line. The adapter plate can for example be welded to the horizontal element. The projections are thus very stable and are practically unable to break off or wear. By means of a symmetrically designed adapter plate, the horizontal element can be correctly connected to the vertical element in various positions.

Particularly preferably, the locking means comprise a cam lever or a stud. In this way any play that is present can be reliably reduced. In particular, a cam lever is particularly suitable for quick installation because such a lever simply has to be moved over in order to achieve the desired locking function and a reduction in any play that may be present.

If the clamping element and the bottom projection of the horizontal element comprise contact surfaces that match each other and that extend at an inclination to the horizontal, securing of the bottom projection of the horizontal element can take place using these contact surfaces by sliding the horizontal element over the contact surfaces to a desired position. The clamping element thereby acts like a wedge during the securing action.

Preferably, the hooking-in aperture is formed by a gap between an outside wall of the vertical element and a contact body in the vertical element for horizontal contact of the free end of the horizontal element. This design is particularly well suited to hooking in projections formed by an adapter plate. In this arrangement, the contact body supports the free end of the horizontal element such that the top projection of the horizontal element is already edge-aligned in a fixed position with the outside wall. In this arrangement, the width of the gap corresponds to the thickness of the top projection, i.e. of the adapter plate.

If, in this arrangement, the horizontal projection on the vertical element, i.e. the projection for vertically supporting the bottom projection of the horizontal element, is formed by a bottom end of the contact body, particularly stable positioning of the elements relative to each other is possible by means of the connection element according to the invention, because only two parts, i.e. the contact body and the horizontal element, are attached to each other. In this way, any play that might be present between additional parts is avoided.

Particularly preferably, the locking means are inserted through preferably one hole vertically through the contact body and are lockable from the top. In this way it is, for example, possible to assemble a substructure of a desk or a platform without having to carry out manipulation from below on the substructure after assembly of said substructure in order to interlock the individual elements. For example, a cam lever can then simply be engaged from above in order to secure the structure. Because the locking means are inserted through the contact body, the locking means, i.e. the entire clamping element, can already be captively installed on the vertical element. In this way, there is no need to separately provide the individual parts of the clamping elements.

In a very advantageous manner, two respective connection elements according to the invention are arranged on a vertical element so as to be symmetrical relative to a mid-plane of the vertical element. In this way, a connection system is created with which a chain of horizontal elements can be constructed using interposed vertical elements. In this way it is for example possible to assemble a desk substructure of any desired length. In this arrangement, the horizontal elements are also symmetrical in design. They comprise at least one further top and bottom projection, i.e. on a further free end and preferably, a further adapter plate.

In such a connection system according to the invention, the arresting means of both connection elements and/or the contact body of both connection elements are preferably designed as one component. If the contact bodies of both connection elements are designed as a single component, any play between the elements of the connection elements is reduced when compared to a design comprising two individual contact bodies. Particularly advantageously, the design of the locking means involves a single component, because, in this manner, both connections can be secured by locking this individual component.

A modular furniture element according to the invention comprises at least one connection element according to the invention and/or at least one connection system according to the invention. A modular furniture element according to the invention is preferably designed as a substructure of a modular furniture desk. In this arrangement, the vertical elements are designed as desk legs with desktop supports and base parts, with the horizontal elements being designed as longitudinal supports, each connecting two desk legs. Such modular furniture desks are particularly suited for use in fairs or exhibitions where quick and secure assembly and disassembly of the modular furniture desks is necessary.

The invention is explained below in more detail by means of an exemplary embodiment with reference to the drawings.

### BRIEF DESCRIPTION OF THE DRAWING

FIGS. 1 show a connection system according to the invention.

FIGS. 2 show the process of locking a connection element according to the invention.

FIG. 3 shows desk legs and longitudinal supports of the substructure of a modular furniture desk according to the invention.

### DESCRIPTION OF THE PREFERRED EMBODIMENT

The figures of the drawings show the object according to the invention in a schematic manner and are not to scale. The individual components of the object according to the invention are shown such that their design is clearly evident.

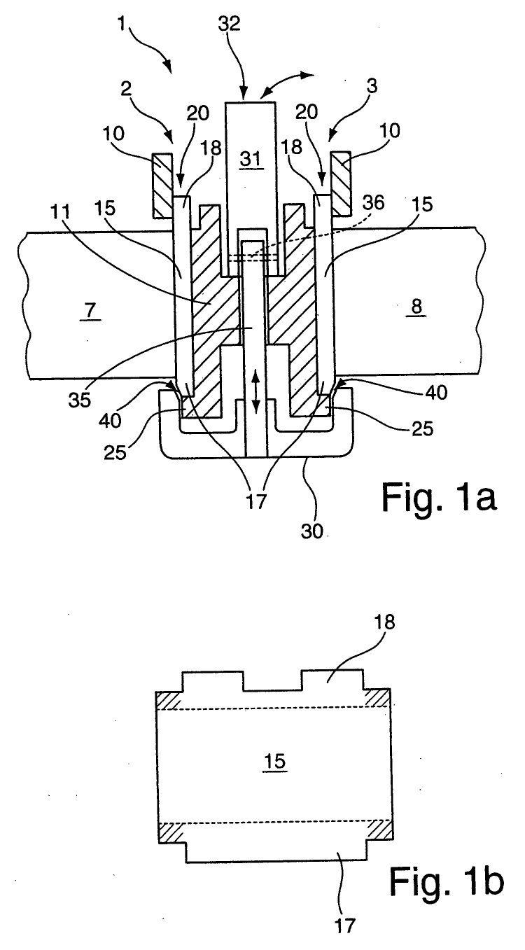

FIGS. 1 show a connection system 1 according to the invention with two connection elements 2, 3 according to the invention, the connection elements 2, 3 being arranged so as to be symmetrical relative to a mid-plane of a vertical element. In each case, a horizontal element 7, 8 is installed on the vertical element via one of the connection elements 2, 3. FIG. 1a shows a section view of the connection system 1 according to the invention which is perpendicular to the mid-plane of the vertical element. Thus, only part of the outside wall 10 and a contact body 11 of the vertical element is shown. FIG. 1b shows a top view of an adapter plate 15, welded to the free ends of the horizontal elements 7, 8. Such adapter plates 15 form top and bottom projections 17, 18 on the free ends of the horizontal elements 7, 8. The adapter plate 15 is a metal plate. In each case the connection elements 2, 3 have a hooking-in aperture 20, designed as a gap, for accommodating the top projections 18 of an adapter plate 15. In each case, these gaps are formed by a space between an outside wall 10 of the vertical element and the contact body 11, arranged in the vertical element, for horizontally contacting (contact surface) the adapter plates 15 which are welded to the free ends of the horizontal elements 7, 8 to be installed. In this arrangement, the gap width corresponds to the thickness of the adapter plates 15. The contact body 11 shown forms a corresponding contact surface for both connection elements 2, 3, i.e. the contact bodies of the two connection elements are designed as a single component. For vertical support of each bottom projection 17 formed by the adapter plates 15 of the horizontal elements 7, 8, a bottom end of the contact body 11 forms a horizontal projection 25 so that the bottom ends are L-shaped. By means of a clamping element 30, the bottom projections 17 of the horizontal elements 7, 8 are secured against horizontal displacement in their vertically supported position. By means of locking means 32 that comprise a cam lever 31, the clamping element 30 is fixed such that the elements of the connection elements 2, 3 are secured relative to each other without any play. The clamping element 30 is also symmetrical in design so that it serves as a clamping element of both the connection elements 2, 3 of the connection system 1 shown. In this arrangement, the locking means 32 of the connection elements 2, 3 are designed as a sole tie bolt 35 with a cam lever 31, wherein the tie bolt 35 is inserted through the contact body 11 in a hole that extends perpendicularly along the mid-perpendicular of the contact body 11. The cam lever 31 is coupled to the tie bolt 35 by way of a securing stud 36 and is lockable from above. By moving the cam lever 31 over, the clamping element 30 is pulled upwards by means of the tie bolt 35 and is pushed against the bottom projections 17 of the horizontal elements 7, 8. The process of moving the cam lever 31 over is indicated in the figure by a curved double arrow. The process of drawing upward the clamping element 30 is shown in the figure by a double arrow in the tie bolt. For this purpose, the bottom projections 17 of the horizontal elements 7, 8 and the clamping element 30 comprise contact surfaces 40 that extend at an incline in relation to the horizontal. The bottom projections 17 thus taper off in a conical manner. When the cam lever 31 is moved over for horizontal securing of the horizontal elements 7, 8, the associated contact surfaces 40 are pushed against each other into a play-free position via the inclined contact surfaces 40. If a contact plate 15 is swiveled onto the contact body 11 (outside wall 10, projection 25), a positive locking connection is created which is also torsionally rigid. In the adapter plate 15 shown in FIG. 1b the contact surfaces appear hatched in the drawing. After installation (activation of the clamping element) of a horizontal element 7, 8 on a vertical element, these contact surfaces generate a non-positive connection with the vertical element. The projections 17, 18, which in FIG. 1b are shown so as to be delimited from the remaining adapter plate by means of dashed lines, can form edge lines with cut-outs as shown. The hooking-in apertures 20 and the shape of the bottom projections 25 on the vertical element are then formed correspondingly. In this way, further positioning of the horizontal elements 7, 8 on the vertical element can be defined.

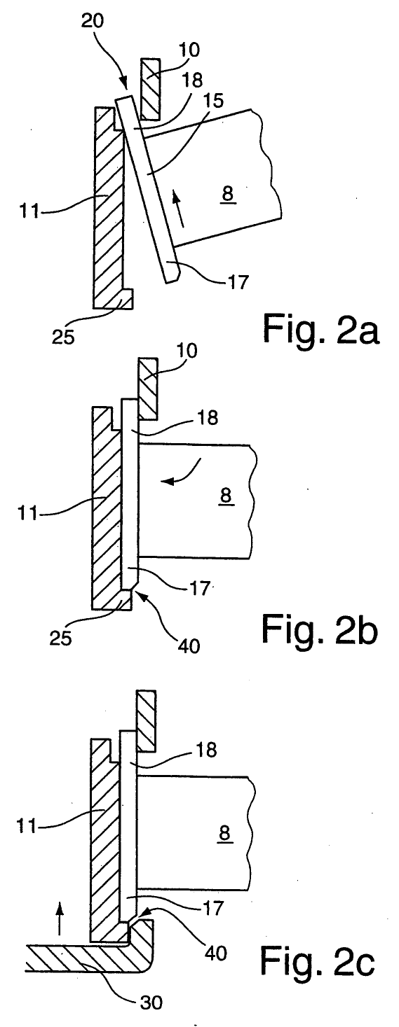

FIGS. 2 show the process of locking a connection element according to the invention during installation of a horizontal element 8 to a vertical element. First, as shown in FIG. 2a, the top projection 18 of the adapter plate 15 which is attached to a free end of the horizontal element 8 is hooked into the hooking-in aperture 20 on the vertical element, which in FIG. 2a is indicated by an arrow. Subsequently the horizontal element 8 is lowered, i.e. swiveled in, on the hooking-in aperture 20 as the center of rotation, until the adapter plate 15 rests against the contact body 11 of the vertical element, which in FIG. 2b is indicated by an arrow. In order to facilitate rotation, in the region of the hooking-in aperture 20, the contact body 11 is designed so as to be set back in relation to the outside wall 10 of the vertical element. As shown in FIG. 2b after the lowering process, the bottom projection 17 of the adapter plate 15 rests against the horizontal projection 25 formed by the bottom end of the contact body. As shown in FIG. 2c by means of an arrow, the clamping element 30 is subsequently pulled upwards by locking means (not shown). The inclined contact surfaces 40 of the clamping element 30 and of the bottom projection 17 are pushed against each other in this way, which results in securing the bottom projection 17 of the horizontal element 8 without any play.

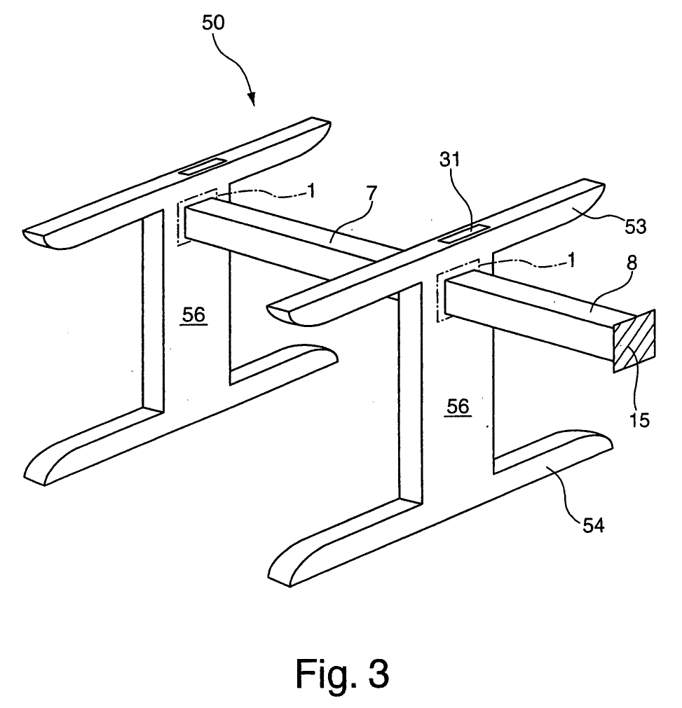

FIG. 3 shows a sequence of desk legs and longitudinal supports of a modular furniture element 50, namely of a substructure, of modular furniture desks according to the invention. A connection system 1 according to the invention is provided on each of the vertical elements 56, which are designed as desk legs with desktop supports 53 and base parts 54, and is indicated in the figure by a dot-dash rectangle. At their free ends, each of the horizontal elements 7, 8, which are designed as longitudinal supports, comprises an adapter plate 15 by means of which they are attached to the desk legs by way of connection elements according to the invention. An engaged cam lever 31 is shown on each surface of the desk legs or their desktop supports 53, whose surface is provided for supporting a desktop.

A connection element 2, 3 for attaching a horizontal element 7, 8 to a vertical element is proposed. In this arrangement, the free end of the horizontal element 7, 8 comprises at least one top projection 18 and at least one bottom projection 17, while on the vertical element 56 at least one hooking-in aperture 20 for accommodating the top projection 18 of the horizontal element 7, 8 and at least one horizontal projection 25 for vertically supporting the bottom projection 17 of the horizontal element 7, 8 are provided, wherein a clamping element 30 with locking means 32 for horizontal securing of the bottom projection 17 of the horizontal element 7, 8 is provided.

The invention is not limited to the exemplary embodiments stated above. Instead, a number of variants are imaginable, which make use of the features of the invention, even in designs that are fundamentally different.

We claim:

1. A connection element for attaching a horizontal member to a vertical member, the element comprising:
means defining at least one upper projection at a free end of the horizontal member;
means defining at least one lower projection at the free end of the horizontal member;
means having at least one hooking-in aperture on the vertical member for accepting said upper projection;
means defining at least one horizontal lip on the vertical member for support of said lower projection; and
a clamping member having locking means to horizontally secure said lower projection.

2. The connection element of claim 1, wherein said upper and lower projections of the horizontal member are formed by a plate that is attached to the free end of the horizontal element.

3. The connection element of claim 2, wherein the plate is symmetrical.

4. The connection element of claim 1, wherein said locking means comprise a cam lever or a stud.

5. The connection element of claim 1, wherein said clamping member and said lower projection of the horizontal member have contact surfaces that match each other and that extend at an incline to the horizontal, said contact surfaces enabling horizontal securing of said lower projection of the horizontal member.

6. The connection element of claim 1, wherein said hooking-in aperture is formed by a gap between an outside wall of the vertical member and a contact body in the vertical member for horizontal contact of the free end of the horizontal member.

7. The connection element of claim 6, wherein said horizontal lip on the vertical member is formed by a bottom end of said contact body.

8. The connection element of claim 6, wherein said locking means are inserted vertically through a hole in said contact body and are lockable from an upper direction.

9. A connection system comprising two of the connection elements of claim 1, wherein the connection elements are arranged to be symmetrical relative to a mid-plane of the vertical member.

10. The connection system of claim 9, wherein said locking means of both connection elements is designed as a single component.

11. The connection system of claim 9, wherein said hooking-in aperture is formed by a gap between an outside wall of the vertical member and a contact body in the vertical member for horizontal contact of the free end of the horizontal member, wherein said locking means of said contact body of both connection elements is designed as a single component.

12. A modular furniture element comprising at least one connection element of claim 1.

13. A modular furniture element comprising at least one connection system of claim 9.

14. A modular furniture desk comprising at least one modular furniture element of claim 12, wherein vertical members are designed as desk legs with desktop supports and base parts and horizontal members are designed as longitudinal supports, each connecting two desk legs.
